(19) United States
(12) Patent Application Publication
(10) Pub. No.: US 2021/0182314 A1
(43) Pub. Date: Jun. 17, 2021

(54) SYSTEMS AND METHODS FOR ON-CHAIN / OFF-CHAIN STORAGE USING A CRYPTOGRAPHIC BLOCKCHAIN

(71) Applicant: Epicenter Corporation, Bethesda, MD (US)

(72) Inventor: Walter J. HANCOCK, Bethesda, MD (US)

(21) Appl. No.: 17/119,970

(22) Filed: Dec. 11, 2020

Related U.S. Application Data
(60) Provisional application No. 62/948,092, filed on Dec. 13, 2019.
(60) Provisional application No. 63/036,848, filed on Jun. 9, 2020.

(51) Int. Cl. G06F 16/27; G06F 16/23; H04L 9/06

(52) U.S. Cl. CPC G06F 16/275; G06F 16/2358; H04L 2209/38; H04L 9/0643; G06F 16/2365

(57) ABSTRACT

A data management method includes performing a CRUD function on data in accordance with a received data envelope and with respect to a database, and storing a hash value on a block of a blockchain, wherein the hash value indicates a location of the data in a permanent storage.

### CROSS REFERENCE TO RELATED APPLICATIONS

This application claims the benefit of U.S. Provisional Application No. 62/948,092, entitled Systems and Methods for Replicating Crud Functionality Using a Cryptographic Block Chain, filed on Dec. 13, 2019; and U.S. Provisional Application No. 63/036,048, entitled Systems and Methods for On-Chain/Off-Chain Storage Using a Cryptographic Blockchain, filed on Jun. 9, 2020, which are hereby incorporated by reference in their entireties.

### FIELD OF THE INVENTION

The present invention relates to systems and methods for on-chain/off-chain storage using a cryptographic blockchain replicating create-read-update-delete (CRUD) functionality in an enterprise IT environment.

### BACKGROUND OF THE INVENTION

A typical enterprise IT environment includes a large number of business applications that perform various operations on data objects stored in databases. The most basic of these operations are the functions of: create, read, update and delete, which are typically referred to as the CRUD functions. Other variations of CRUD include but are not limited to: browse-read-edit-delete (BREAD), delete-add-view-edit (DAVE), create-replicate-append-process (CRAP) and create-read-update-delete-experience (CRUDE). CRUD functionality is typically utilized in storing large amounts of data via databases, where data is created, read, updated and deleted within the database according to the CRUD functions applied thereto.

Cryptographic block chain technology has been utilized to remove the characteristic of infinite reproducibility from digital assets, e.g., cryptocurrency, by creating a generally immutable record of transactions involving the digital assets. A block chain, or data chain, generally refers to a growing list of records, called blocks, which are linked using cryptography. In general, when a user requests a transaction related to the digital asset, the requested transaction is broadcast to a peer-to-peer (P2P) network that validates the transaction using one or more algorithms. Once verified, the transaction (or more precisely a record of the transaction) is cryptographically linked, as a new block, to an existing block chain reflecting the totality of transactions for that digital asset, in a way that the record is generally permanent and unalterable.

The block chain features of permanence and inalterability are desirable in secure data storage. However, because block chains are cryptographic chains, they are not good at storing data beyond the records of the individual transactions forming the blocks. Accordingly, while blockchains are well-suited for storing transaction data, they are not well-suited for storing large amounts of data—and are therefore unsuitable for big data applications. As more data (and more complex data) is stored on the block chain, the block chain becomes unwieldy.

Because of this, it has been suggested to add functionality to block chains in order to enable the block chains to store large amounts of data. Adding such functionality generally requires modification of the block chain server and/or nodes, and results in the additional functionality being unique to the underlying block chain technology. Moreover, off-chain storage techniques have been explored in which non-transactional data (e.g., JPEG, DOC, PDF, etc.) is stored off-chain.

It is an object of the disclosure to provide systems and methods for utilizing a block chain to replicate CRUD functionality so as to provide on-chain/off-chain storage that is substantially blockchain agnostic. It is a further object of the disclosure to provide systems and methods for storing data via the replication of CRUD functionality with the block chain. It is a still further object of the disclosure that the replication of CRUD functionality and the on-chain/off-chain storage is substantially blockchain agnostic—i.e., the functionality can be implemented via substantially any block chain technology where the block chain can store a hash, i.e., a memo or a channel, or the like—and is able to be used to store big data off-chain while taking advantage of the features of the blockchain.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure use terminology and acronyms that may not be familiar to the layperson, those skilled in the art will be familiar with the terminology and acronyms used herein.

### BRIEF DESCRIPTION OF THE DRAWINGS

The features, objects, and advantages of aspects of the disclosed embodiments will become more apparent from the detailed description, set forth below, when taken in conjunction with the drawings, in which like reference characters identify correspondingly throughout.

FIG. 1 schematically illustrates a blockchain-based data storage system in accordance with at least one embodiment;

FIG. 2 schematically illustrates an exemplary structure of the envelopes and the corresponding blockchain in accordance with at least one embodiment;

FIG. 3 illustrates an exemplary database table in accordance with at least one embodiment.

FIG. 4 illustrates exemplary code in accordance with at least one embodiment;

FIGS. 5A-5B illustrate exemplary field codes of data envelopes in accordance with at least one embodiment;

FIG. 6 schematically illustrates exemplary operations in accordance with at least one embodiment; and

FIG. 7 is a flow-chart illustrating exemplary methods in accordance with at least one embodiment.

### DETAILED DESCRIPTION OF THE DRAWINGS

The drawing figures illustrate aspects of the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one embodiment of the invention with the understanding that the present disclosure is to be considered as an exemplification of the principles of the present invention, and is not intended to limit the broad aspects of the present invention to any embodiment illustrated. It will therefore be understood that what is illustrated is set forth for the purposes of example, and should not be taken as a limitation on the scope of the present invention.

In the following detailed description and corresponding figures, numerous specific details are set forth in order to provide a thorough understanding of the present invention. However, it should be appreciated that the invention may be practiced without such specific details. Additionally, for brevity sake well-known methods, procedures, components, and circuits have not been described in detail.

Exemplary systems and methods for on-chain/off-chain storage with a generic blockchain, or data chain, via the replication of CRUD functionality within the generic block chain, in accordance with one or more aspects of the disclosure will now be described with reference to the Figures. As used herein, the terms generic and agnostic, with reference to a blockchain, refers to the fact that any blockchain technology where the blockchain can store a hash, i.e., a memo or a channel, or the like, may be utilized.

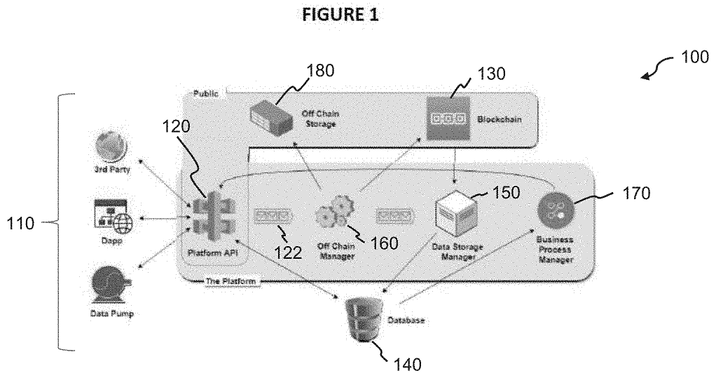

FIG. 1 generally illustrates a blockchain-based data storage system 100 comprising: a platform API 120, a database 140, an off-chain manager 160, an off-chain storage 180, a blockchain 130, a data storage manager 150 and a business process manager 170.

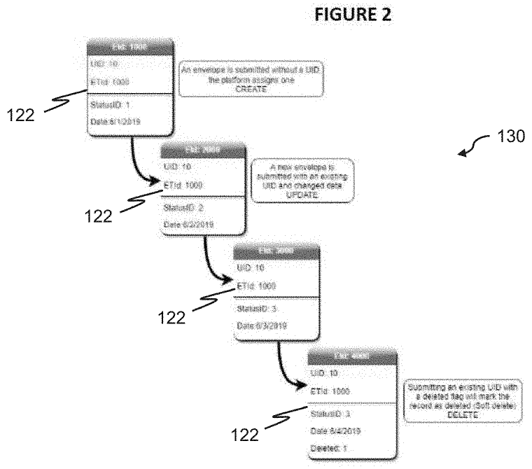

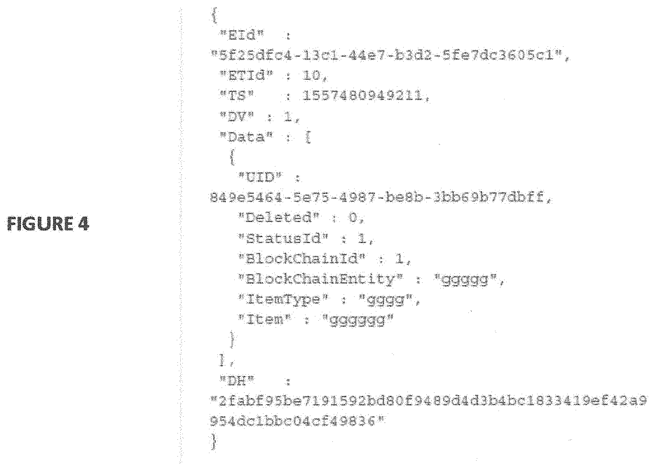

In operation, the platform API 120 generally receives and manages CRUD function requests, i.e., requests to create, read, update or delete data. The platform API 120 accepts the data, as part of a received data envelope 122, determines which CRUD function(s) need to be done with the data, and communicates the data to the appropriate system component for further appropriate action. In general, the platform API 120 communicates the data via envelopes 122. The envelopes 122 are preferably JavaScript Object Notation (JSON) objects, with the format illustrated in FIGS. 2-5.

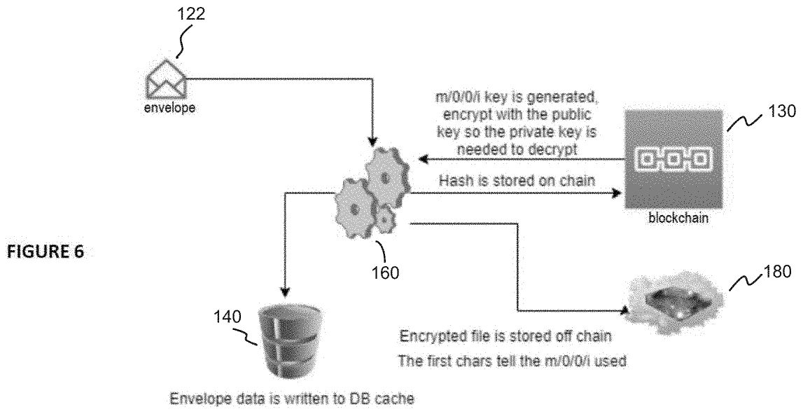

The platform API 120 is configured to encrypt and hash the data, and to transmit the data to the off-chain manager 160, which in turn is configured to transmit the encrypted data to the off-chain storage 180 and to store the hash value of the encrypted data to the blockchain 130, such that the hash value reflects the storage location of the encrypted data within the off-chain storage 180. The off-chain storage 180 is preferably a permanent data storage for storing the data, and may be a public data storage. The blockchain 130 thus operates as a cryptographic ledger of the CRUD functions applied to the data stored on the off-chain storage 180. A further discussion of the on-chain/off-chain storage will be had in connection with FIG. 6.

The blockchain 130 may be, in turn, read by the data storage manager 150, which updates the database 140 accordingly. The database 140 is a transient storage for storing the data, and may be accessed by a data store layer of an accessing computer 110. The platform API 120 also communicates with the database 140 to retrieve the data stored thereon.

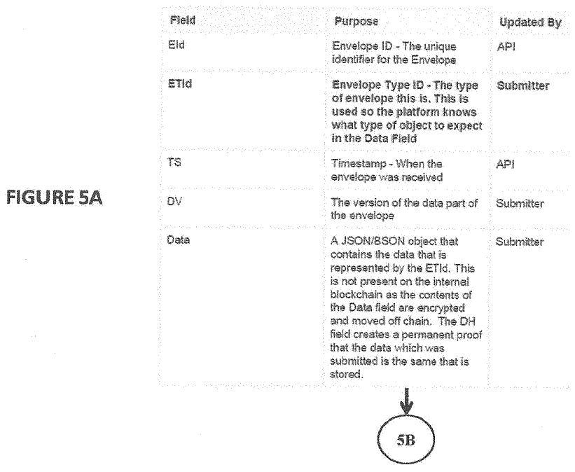

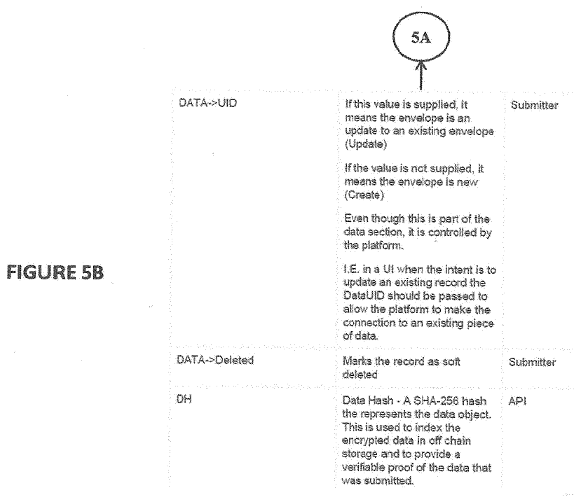

FIGS. 2-5 generally illustrate the structure of the envelopes 122 and the corresponding blockchain 130. As shown, each envelope 122 includes a type and a universal identification (UID), which together represents the location of the data in the database 140. Each envelope 122 also includes a hash (i.e., a memo or channel) that represents the location of the data in the off-chain storage 180, if any. Other fields may be as shown in at least FIG. 5.

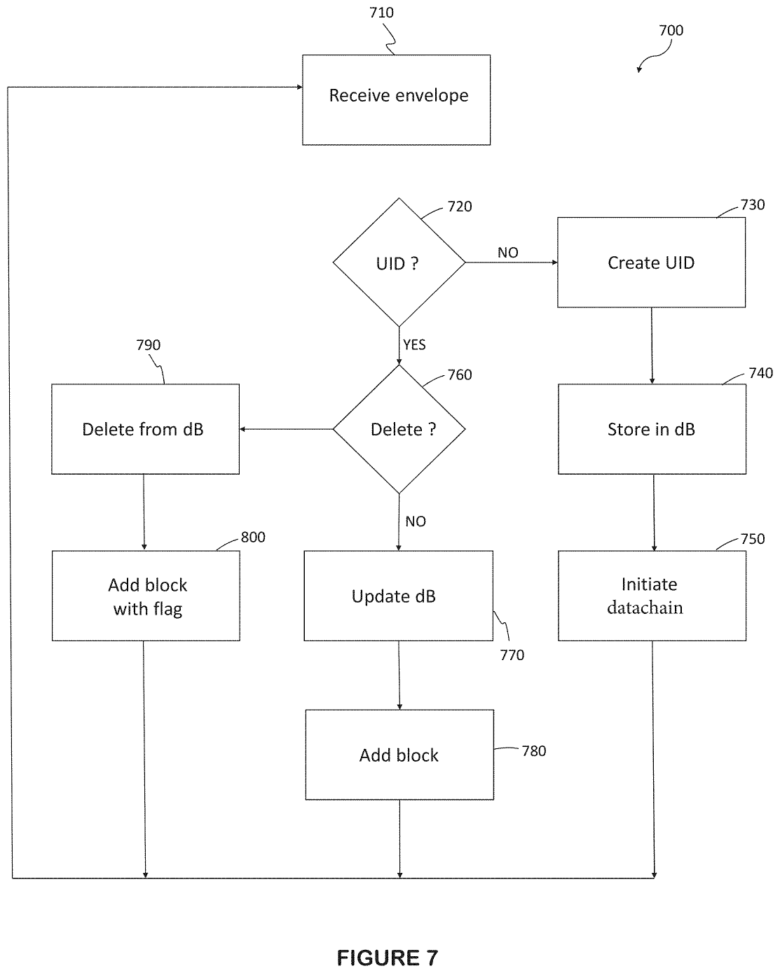

In operation, as shown for example in FIGS. 6-7, the envelopes 122 correspond to the blocks of the blockchain 130, and are connected via cryptographic blockchain methodologies. Each data that is sent to the platform API 120 has a type or ETId. This is similar to a table in a relational database management system (RDBMS). FIG. 7 shows an exemplary method 700 in accordance with at least one embodiment.

At step 710, the API 120 receives the data envelope 122, which is checked for an existing UID (step 720). When the envelope 122 received by the platform API 120 does not contain a UID, it is considered a new record for the type indicated. The platform API 120 accordingly assigns a UID to the envelope 122 (step 730). The data is stored in the database 140, the location of the data being indicated by the type and UID (step 740). The data is also stored in the off-chain storage 180 as indicated herein, the location of the data being indicated by the hash value (740). The envelope 122 then starts the datachain (step 750). As such, the create CRUD function is substantially replicated in the blockchain 130.

When the envelope 122 received by the platform API 120 does contain a UID, it is considered an updated record. The corresponding data in the database 140 is updated in accordance with known methods (step 770). The data is also stored in the off-chain storage 180, as indicated herein (step 770). The location of the data in the off-chain storage is identified by a hash value, as indicated herein. The envelope 122 indicating the update is added to the blockchain 130 (step 780). The related envelopes 122 of the blockchain 130 (i.e., the data chain) are accordingly able to be processed, particularly in the order received, so as to recreate all changes to a given data item. An exemplary data chain 130 is illustrated in FIG. 2. As such, the update CRUD function is substantially replicated in the blockchain 130.

When the envelope 130 received by the platform both contains a UID and a delete flag, it is considered a delete (step 760). The corresponding data in the database 140 is deleted in accordance with known methods (step 790). However, since the blockchain is immutable, this is a soft delete with respect to the off-site storage 180. A corresponding block having the delete flag is therefore added to the data chain (step 800). Thus, all of the previous data exists, but a NOT can be filtered out during a query of the blockchain 130 by using the flag. As such, the delete CRUD function is substantially replicated in the blockchain 130.

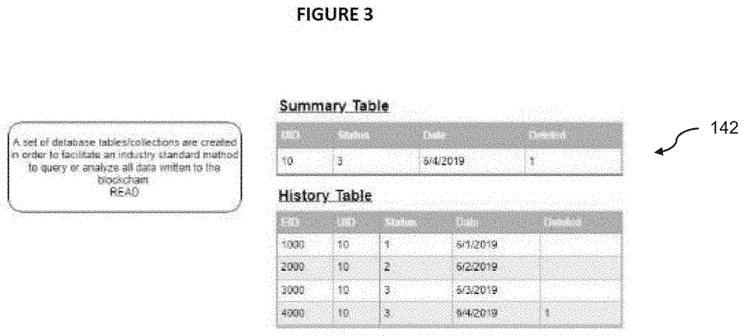

Such a query of the blockchain 130 may substantially replicate the read CRUD function. However, in order to quickly process and query the information contained in the blockchain 130, the database 140 may be built from the envelopes 122 created on the blockchain 130. The database 140 acts as a data cache that enables complex business logic, analysis and/or display of all data in the enterprise IT environment. While the blockchain 130 contains all the data in the network/application in an encrypted format, the database/cache contains non-encrypted data that is specific to the user/users that own the node. Moreover, as the database 140 tables/correlations are such as to facilitate the querying or analyzing all data written to the blockchain 130, the database 140 tables/correlations substantially replicate the read CRUD function. An exemplary database table 142 is shown, for example, in FIG. 3.

Returning to FIG. 1, the business process manager is configured to instruct the platform API on what to do with the data that is received based on business rules. For example, where the enterprise IT environment is that of a home loan company, the CRUD request may be to update a digitally stored loan document to indicate that it was electronically signed. This may trigger other updates, deletions or other applications CRUD functions to other data according to business rules. The business process manager may accordingly instruct the platform API in the execution of those actions.

Accordingly, the system utilizes a blockchain structure to substantially replicate CRUD functionality, and also ensures that one immutable version of the true CRUD history is maintained. In this manner, the blockchain and off-site storage maintains the integrity of the data storage, while the database functions primarily as a query tool.

FIGS. 6-7 schematically illustrate example operations of the off-chain/on-chain storage according to at least one embodiment.

On receiving the envelope, the platform API encrypts the envelope data (i.e., the non-transactional data, or other data to be stored) using an encryption scheme. The encryption scheme can be symmetric or asymmetric encryption schemes, and preferably utilizes elliptical curve key generation methodology. For example, the encryption scheme is, in at least one embodiment, AES-265 or SHA-256. In at least one embodiment, the platform API, via the encryption scheme, generates a new key for each received envelope.

The platform API subsequently generates a hash value for the encrypted envelope data via the application of a hash function. The hash value is added to the envelope, as discussed above, and is unique to the encrypted envelope data. Because the hash value is the result of hashing the encrypted envelope data, rather than the unencrypted envelope data, the hash value (which is stored on the blockchain, as described herein) can be validated without decrypting the envelope data. This allows for the verification of the encrypted data without compromising the integrity of the encrypted data (which is stored on the off-chain storage, as discussed herein).

The platform API transmits the encrypted envelope data to the off-chain manager, which in turn stores the encrypted envelope data on the off-chain storage in association with the hash value, as discussed above. In some embodiments, the encrypted envelope data is stored on the off-chain storage as a data file with the associated hash value as the file_name.

The platform API also transmits the envelope information, i.e., the envelope without non-transactional data that was saved to the off-chain storage, to the off-chain manager, which in turn writes the envelope information to the blockchain, as discussed herein. The writing of the envelope information to the blockchain substantially corresponds writing the appropriate CRUD function to the blockchain, as discussed herein. The database may also be updated with a transaction identification to reflect the successful writing of the envelope information to the blockchain.

It will be understood that the off-chain manager may receive the envelope, envelope data and/or envelope information directly or indirectly from the platform API. In some embodiments, a data-stream intermediary or messaging queue software may be used as a relay between the platform API and the off-chain manager. An example, of one such data-stream intermediary/message queue software is Apache Kafka.

In this manner, big data may be stored off-chain while its integrity is secured via on-chain storage of its associated hash value. Moreover, this on-chain/off-chain storage may further be utilized with associated CRUD functionality such that storage databases may be verified—and may further be rebuilt from the blockchain and the encrypted files.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the disclosed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described herein with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

Furthermore, the operations described herein may be implemented via hardware, software, firmware or any combination thereof, unless expressly indicated otherwise. If implemented in software, the operations may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules, engines, logic and/or other appropriate means for performing the operations described herein may be utilized in implementing the operations described herein.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc. While the invention may be used in connection with C, C++, VB6, .Net suite, Java/J2EE, Cobol, DCLGEN, JCL, PL/SQL, and Oracle Forms, it should be appreciated that the invention may be equally applicable to other known or future programming languages as well.

In accordance with the descriptions herein, the term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

The term “computer readable medium” refers to any non-transitory media that participates in providing instructions to a processor for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like.

The terms “module” and “engine” refer to hardware, firmware, software in execution on a machine, and/or combinations of each to perform a function(s) or an action(s), and/or to cause a function or action to occur from another module, engine, method, and/or system. The terms may include a software controlled microprocessor, a discrete logic (e.g., ASIC), an analog circuit, a digital circuit, a programmed logic device, a memory device containing instructions, and so on. This may also include one or more gates, combinations of gates, or other circuit components.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosure and equivalents thereof.

1. A data management method, comprising:
performing a CRUD function on data in accordance with a received data envelope and with respect to a database;
storing a hash value on a block of a blockchain, wherein the hash value indicates a location of the data in a permanent storage.

2. The data management method of claim 1, wherein the CRUD function is a create function, and the block is an initial block of the datachain.

3. The data management method of claim 1, wherein the CRUD function is an update function, and the block is an additional block to the datachain.

4. The data management method of claim 1, wherein the CRUD function is a delete function, and the block is an additional block to the datachain and includes a delete indicator.

5. The data management method of claim 1, wherein the CRUD function is a read function, and the data is read from at least one of: the database and the permanent storage.

6. The data management method of claim 1, further comprising:
creating the database from the blockchain and the permanent storage.

7. The data management method of claim 1, further comprising:
encrypting the data stored in the permanent storage, wherein the hash value is of the encrypted data.

8. A data management system, comprising:
a database;
a permanent storage;
a processor configured to perform a CRUD function on data in accordance with a received data envelope and with respect to the database; and
a blockchain manager configured to store a hash value on a block of a blockchain, wherein the hash value indicates a location of the data in the permanent storage.

9. The data management system of claim 8, wherein the CRUD function is a create function, and the block is an initial block of the datachain.

10. The data management system of claim 8, wherein the CRUD function is an update function, and the block is an additional block to the datachain.

11. The data management system of claim 8, wherein the CRUD function is a delete function, and the block is an additional block to the datachain and includes a delete indicator.

12. The data management system of claim 8, wherein the CRUD function is a read function, and the data is read from at least one of: the database and the permanent storage.

13. The data management system of claim 8, wherein the processor is further configured to create the database from the blockchain and the permanent storage.

14. The data management system of claim 8, wherein the processor is further configured to encrypt the data stored in the permanent storage, and the hash value is of the encrypted data.
